(19) United States
(12) Patent Application Publication
(10) Pub. No.: US 2002/0038957 A1
(43) Pub. Date: Apr. 4, 2002

(54) Apparatus for picking up animal waste

(76) Inventor: Carl Harrison, Mt. Vernon, NY (US)

Correspondence Address: Matthew J. Peirce, Esq., 1550 Starlight Canyon Avenue, Las Vegas, NV, 89123, US

(21) Appl. No.: 09/970,473

(22) Filed: Oct. 3, 2001

Related U.S. Application Data
(60) Provisional application No. 60/237,130, filed on Oct. 3, 2000.

(51) Int. Cl. A01K 29/00

(52) U.S. Cl. 294/1.4

(57) ABSTRACT

A new and improved apparatus for picking up animal waste that an animal has left behind is disclosed. The apparatus would have a scoop portion, a handle portion, and a pole which would connect the two. The pole would be approximately three to four feet long, which would allow a user to use the present invention without having to bend over or to squat down. The handle portion would have a trigger which would connect to a spring lever which would travel through the inside of the pole and connect with a pivotable cover on the scoop portion. By activating the trigger, a user would be able to open and close the pivotable cover on the hinge portion.

### BACKGROUND OF THE INVENTION

The present invention concerns that of a new and improved apparatus for picking up animal waste that an animal has left behind.

### DESCRIPTION OF THE PRIOR ART

U.S. Pat. No. 5,820,179, issued to Tsou, discloses a refuse collection device which includes an elongated tubular assembly comprising an inner tube, an intermediate tube and an outer tube telescoping each other and a bag mount supporting thereon a refuse collection bag attached to the lower end of the tubular assembly and closable by means of a pivoting cover.

U.S. Pat. No. 5,540,470, issued to Lu, discloses a collecting device used to collect refuse as animal droppings or any matter thrown on the ground in a sanitary and convenient manner that allows the collector to keep hands clean.

U.S. Pat. No. 5,320,393, issued to Cortinas, discloses an improved device for collecting refuse by using a fixed holding member and moveable expander to releasably hold a bag open by virtue of tension forces exerted across the mouth of the bag.

U.S. Pat. No. 4,368,907, issued to Ross, discloses a device for use in gathering and removing animal waste and other debris.

### SUMMARY OF THE INVENTION

The present invention concerns that of a new and improved apparatus for picking up animal waste that an animal has left behind. The apparatus would have a scoop portion, a handle portion, and a pole which would connect the two. The pole would be approximately three to four feet long, which would allow a user to use the present invention without having to bend over or to squat down. The handle portion would have a trigger which would connect to a spring lever which would travel through the inside of the pole and connect with a pivotable cover on the scoop portion. By activating the trigger, a user would be able to open and close the pivotable cover on the hinge portion.

There has thus been outlined, rather broadly, the more important features of a apparatus for picking up animal waste in order that the detailed description thereof that follows may be better understood and in order that the present contribution to the art may be better appreciated. There are, of course, additional features of the apparatus for picking up animal waste that will be described hereinafter and which will form the subject matter of the claims appended hereto.

In this respect, before explaining at least one embodiment of the apparatus for picking up animal waste in detail, it is to be understood that the apparatus for picking up animal waste is not limited in its application to the details of construction and to the arrangements of the components set forth in the following description or illustrated in the drawings. The apparatus for picking up animal waste is capable of other embodiments and being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods and systems for carrying out the several purposes of the present apparatus for picking up animal waste. It is important, therefore, that the claims be regard as including such equivalent constructions insofar as they do not depart from the spirit and scope of the present invention.

It is therefore an object of the present invention to provide an apparatus for picking up animal waste which has all of the advantages of the prior art and none of the disadvantages.

It is another object of the present invention to provide an apparatus for picking up animal waste which may be easily and efficiently manufactured and marketed.

It is another object of the present invention to provide an apparatus for picking up animal waste which is of durable and reliable construction.

It is yet another object of the present invention to provide an apparatus for picking up animal waste which is economically affordable and available to the buying public.

It is yet another object of the present invention to provide an apparatus for picking up animal waste which provides additional benefits not present in the prior art.

Other objects, features and advantages of the present invention will become more readily apparent from the following detailed description of the preferred embodiment when considered with the attached drawings and appended claims.

### BRIEF DESCRIPTION OF THE DRAWINGS

FIG. 1 shows a side view of the handle portion of the present invention.

FIG. 2 shows a front view of the rear face of the scoop portion of the present invention.

FIG. 3 shows a perspective view of the present invention.

### DESCRIPTION OF THE PREFERRED EMBODIMENT

FIG. 1 shows a side view of the handle portion 2 of the present invention. A plurality of rivets 4 can be seen, along with trigger 6, pole 8, and spring lever 10. By pulling trigger 6, spring lever 10 will be tightened, allowing a user to control other portions of the present invention.

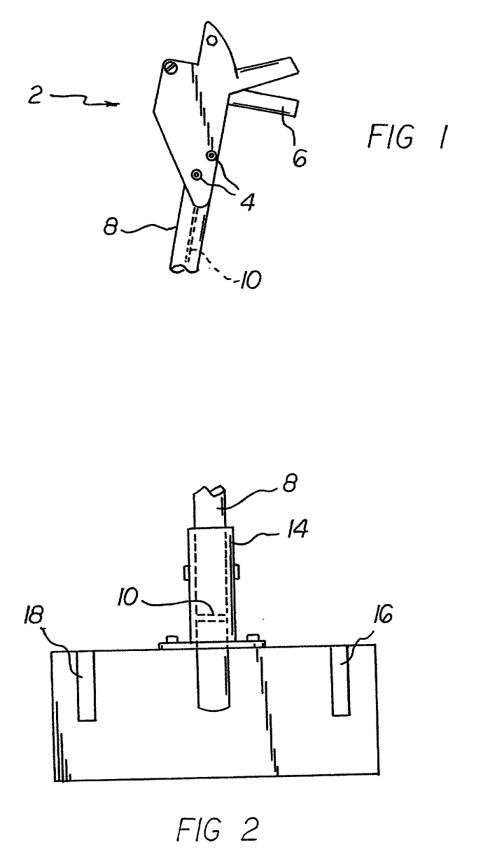

FIG. 2 shows a front view of the rear face of the scoop portion 12 of the present invention. Pole 8 can be seen inserted into pole bracket 14, along with spring lever 10 and spring hinges 16 and 18. Spring lever 10 connects with spring hinges 16 and 18, which will open or close cover 20 when a user tightens or loosens spring lever 10 by pulling or releasing trigger 6 on handle portion 2. Pole bracket 14 is riveted to the outer surface of scoop portion 12.

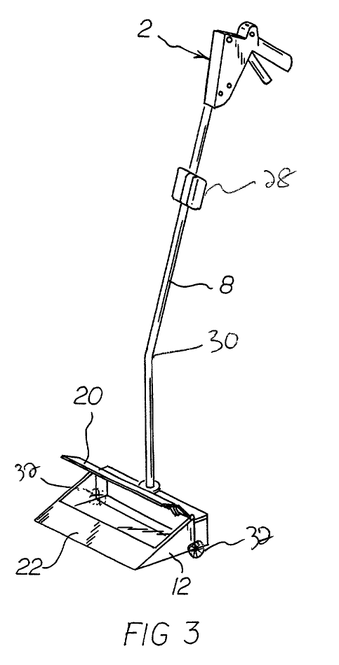

FIG. 3 shows a perspective view of the present invention. As can be seen, scoop portion 12 also has slanted shovel 22 on the bottom of scoop portion 12, allowing for easy pickup for animal waste and other desired objects to be picked up. Pole 8 also has a holder 28, which would be used to hold a flashlight, disinfectant, or other useful material for use while picking up animal waste.

Scoop portion 12 also would have a pair of bottom-mounted wheels 32. The wheels 32 would allow the scoop portion 12 to be more easily moved around when the present invention would be in use.

Pole 8 would have a slight bend 30 located at least one point along its length, with the bend 30 designed to allow the shovel compartment to be parallel with a ground surface while also allowing a user to hold the handle portion at a slightly different angle than exactly perpendicular to the ground surface. This bend 30 would provide for ease of use for the shovel compartment, while at the same time, allow a user greater flexibility in holding the handle portion 2.

What I claim as my invention is:

1. An apparatus for picking up animal waste comprising:
(a) a shovel compartment, the shovel compartment having an open top,
(b) a cover pivotally attached to the top of the shovel compartment, the cover designed to cover the open top when in a down position,
(c) a pair of spring hinges, a first spring hinge and a second spring hinge, each spring hinge having two ends, a first end and a second end, the first end of each spring hinge attached to the inside surface of the cover, the second end of each spring attached to the inside surface within the shovel compartment,
(d) a bracket attached to the outside of the shovel compartment,
(e) a handle portion, the handle portion including a trigger, the trigger being pivotally attached to the handle portion,
(f) a pole having two ends, a first end and a second end, the first end of the pole attached to the handle portion, the second end of the pole attached to the bracket,
(g) a spring lever having two ends, a first end and a second end, the spring lever being primarily located within the length of the pole, the first end of the spring lever attached to the trigger, the second end of the spring lever attached to the pair of spring hinges,
(h) wherein engaging the trigger would tighten the spring lever, causing the second end of the spring lever to pull on the pair of spring hinges, causing the cover to pivotally move in relation to the shovel compartment, which would cause the cover to open or close.

2. An apparatus for picking up animal waste according to claim 1 wherein the apparatus further comprises an item holder, the item holder being attached to the pole.

3. An apparatus for picking up animal waste according to claim 1 wherein the pole would have a slight bend located at least one point along its length, the bend designed to allow the shovel compartment to be parallel with a ground surface while also allowing a user to hold the handle portion at a slightly different angle than exactly perpendicular to the ground surface.
